(19) United States
(12) Patent Application Publication
(10) Pub. No.: US 2006/0178856 A1
(43) Pub. Date: Aug. 10, 2006

(54) Systems and methods for monitoring transaction devices

(76) Inventors: Keith Roberts, Glendale, WI (US); Charles Bram, Fox Point, WI (US); John Emmerichs, Brown Deer, WI (US); Richard Wood, Bayside, WI (US); Christopher Parrott, Tattenhall (GB); James Kohn, Shorewood, WI (US)

Correspondence Address: MICHAEL BEST & FRIEDRICH, LLP, 100 E WISCONSIN AVENUE, MILWAUKEE, WI, 53202, US

(21) Appl. No.: 11/330,030

(22) Filed: Jan. 11, 2006

Related U.S. Application Data
(63) Continuation-in-part of application No. 11/243,327, filed on Oct. 4, 2005.
Application No. 11/243,327 is a continuation of application No. 11/159,847, filed on Jun. 22, 2005.
(60) Provisional application No. 60/649,905, filed on Feb. 4, 2005.

(51) Int. Cl. G06F 11/30

(52) U.S. Cl. 702/186

(57) ABSTRACT

A graphical user interface for use with a plurality of transaction devices. In one embodiment, the graphical user interface includes a plurality of detail screens including detail information associated with a plurality of measurable features of the plurality of transaction devices, and a summary screen including a summary section for each of the measurable features and a detail selection mechanism for each of the measurable features.

### RELATED APPLICATIONS

The present application is a continuation-in-part of co-pending U.S. patent application Ser. No. 11/243,327 titled “METHODS AND SYSTEMS FOR PROVIDING A USER INTERFACE USING FORMS STORED IN A FORM REPOSITORY,” filed on Oct. 4, 2005, which is a continuation of co-pending U.S. patent application Ser. No. 11/159,847 titled “RULES-BASED SYSTEM ARCHITECTURE AND SYSTEMS USING THE SAME,” filed on Jun. 22, 2005, which claims priority to U.S. Provisional Patent Application Ser. No. 60/649,905 of the same title, filed on Feb. 4, 2005, the entire contents of which are all herein incorporated by reference.

### BACKGROUND OF THE INVENTION

Monitoring a system that includes a number of devices, such as a system of automated teller machines (“ATMs”) or other transaction devices, can be critical to the efficient and effective management of the system. To provide status and feedback, each device included in a system can log and accumulate information related to the current status of the device, the past operations performed by the device, any past errors encountered by the device, etc. This information can be reviewed by a manager of the device in order to configure the device for more efficient or effective operation.

### SUMMARY OF THE INVENTION

In some embodiments, it may be important to configure each device included in the system based on the operation of the complete system rather than solely on the operation of each device. Some embodiments of the invention therefore provide a graphical user interface for use with a plurality of transaction devices that includes a plurality of detail screens including detail information associated with a plurality of measurable features of the plurality of transaction devices and a summary screen including a summary section for each of the plurality of measurable features of the plurality of transaction devices and a detail selection mechanisms for each of the plurality of measurable features of the plurality of transaction devices.

Additional embodiments provide a method of monitoring a plurality of transaction devices. The method includes receiving information from the plurality of transaction devices, the information related to a plurality of measurable features of the plurality of transaction devices and generating a summary screen based on the information, the summary screen including a summary section for each of the plurality of measurable features and a detail selection mechanism for each of the plurality of measurable features.

### BRIEF DESCRIPTION OF THE DRAWINGS

FIG. 1 illustrates a system including a plurality of transaction devices and an interface for monitoring the status and operation of the plurality of transaction devices according to one embodiment of the invention.

FIG. 2 illustrates the interface of FIG. 1 according to one embodiment of the invention.

FIG. 3 illustrates a logon screen displayed by the interface of FIG. 1 according to one embodiment of the invention.

FIG. 4 illustrates a summary view screen displayed by the interface of FIG. 1 according to one embodiment of the invention.

FIG. 5 illustrates an automated teller machine status screen displayed by the interface of FIG. 1 according to one embodiment of the invention.

FIG. 6 illustrates an acquirer/issuer activity screen displayed by the interface of FIG. 1 according to one embodiment of the invention.

FIG. 7 illustrates a settlement position screen displayed by the interface of FIG. 1 according to one embodiment of the invention.

FIG. 8 illustrates a user preferences screen displayed by the interface of FIG. 1 according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments of the invention include both hardware and software components or modules that, for purposes of discussion, can be illustrated and described as if the majority of the components were implemented solely in hardware. However, one of ordinary skill in the art, and based on a reading of this detailed description, would recognize that, in at least one embodiment, the electronic based aspects of the invention can be implemented in software. As such, it should be noted that a plurality of hardware and software based devices, as well as a plurality of different structural components can be utilized to implement the invention. Furthermore, and as described in subsequent paragraphs, the specific configurations illustrated in the drawings are intended to exemplify embodiments of the invention and that other alternative configurations are possible.

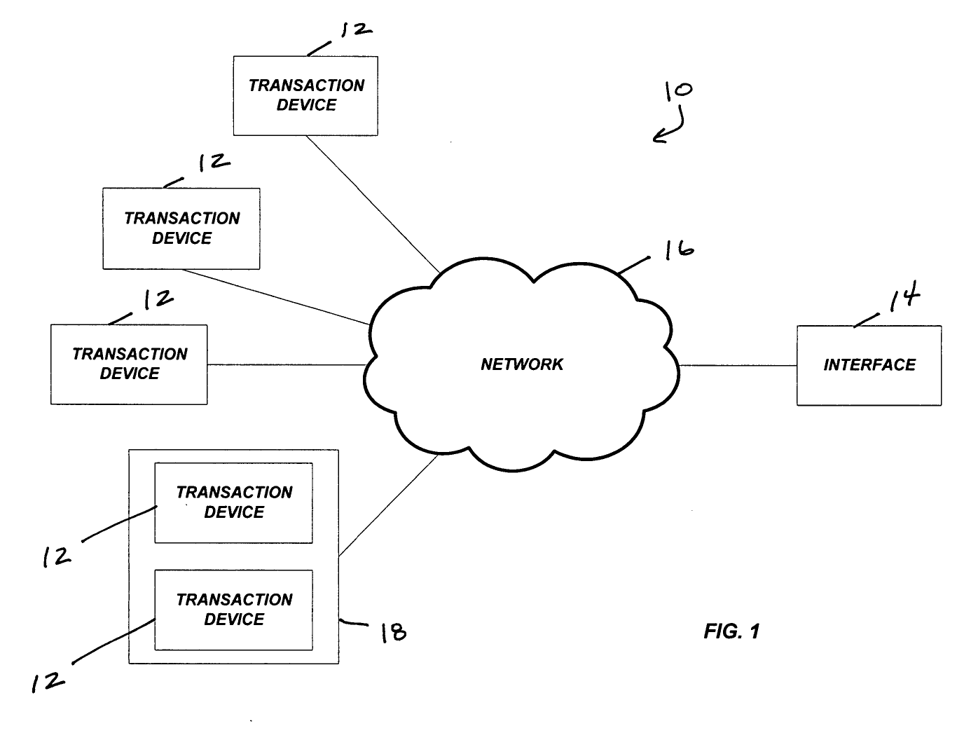

FIG. 1 illustrates a system 10 including a plurality of transaction devices 12 and an interface 14 for monitoring the status of the plurality of transaction devices 12 according to one embodiment of the invention. As shown in FIG. 1, the interface 14 can be connected to the transaction devices 12 via a network 16. The network 16 can include one or more types of network connections, such as a local area network (“LAN”), a wide area network (“WAN”), or the Internet. For example, the transaction devices 12 can be connected to one or more dedicated transaction networks and the interface 14 can be connected to the dedicated transaction network via the Internet. The network connections can include wireless connections, wired connections, or a combination thereof.

In some embodiments, the transaction devices 12 include automated teller machines (“ATMs”), point-of-sale (“POS”) devices, kiosks for effecting transactions, such as financial transactions, money transfers, ticket purchases, or consumer goods purchases, and/or other electronic financial transaction devices. The transaction devices 12 can also include one or more databases that store status and/or other information related to the operation of one or more transaction devices 12, such as ATMs. As shown in FIG. 1, the transaction devices 12 can also include one or more systems or networks of transaction devices 18, such as one or more networks of ATMs.

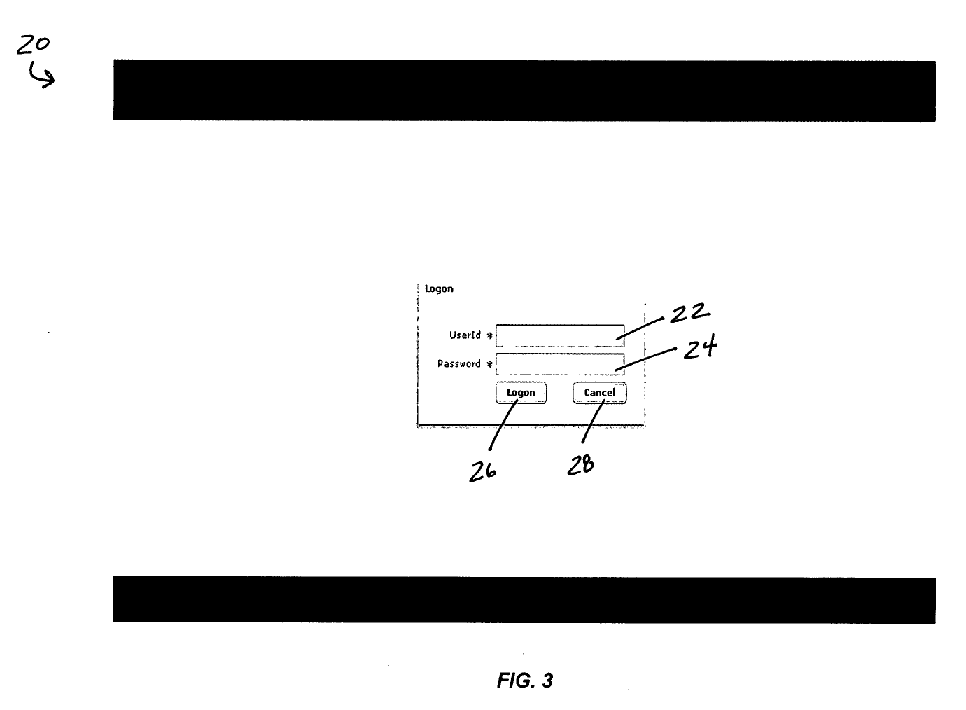

The interface 14 collects information from the transaction devices 12 and generates and displays screens based on the information. In some embodiments, the information collected by the interface 14 includes management-level information regarding the state or status of the transaction devices 12. As described below with respect to FIGS. 3-8, the interface 14 can display the collected information in a summary screen and/or one or more detailed screens. Each detailed screen can display information associated with a particular “information pack,” such as ATM status, acquirer/issuer activity, and settlement position, that represents a particular measurable feature (e.g., status) of the system 10. Each information pack can include particular information from the transaction devices 12. In some embodiments, if one or more transaction devices 12 cannot provide the information included in an information pack, the interface 14 can disable the information pack and can disable the one or more screens or sections of screen associated with the disabled information pack.

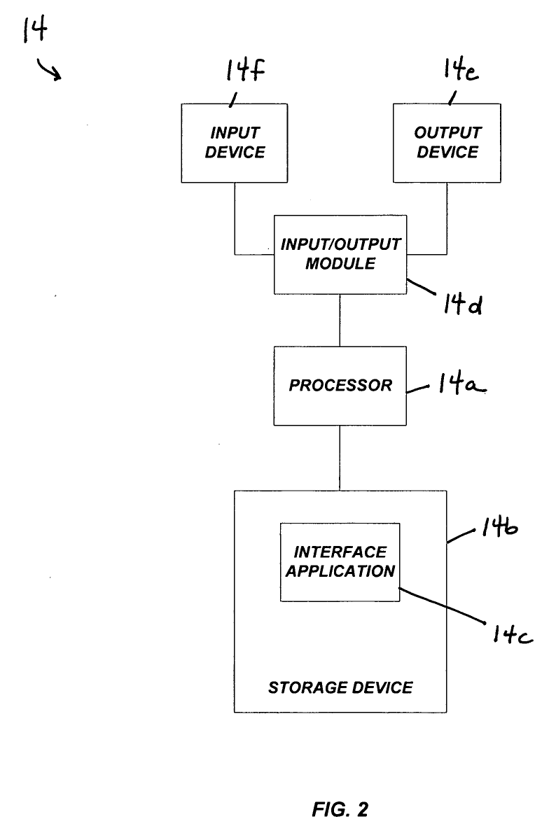

FIG. 2 illustrates the interface 14 according to one embodiment of the invention. As shown in FIG. 2, the interface 14 can include one or more processors 14a and one or more storage devices 14b. The storage devices 14b can include non-volatile memory, such as read-only memory (“ROM”) and/or disk drives, volatile memory, such as random access memory (“RAM”), or combinations thereof. The storage devices 14b can store an interface application 14c, such as a browser-based application, that is executed by the processors 14a. For example, the interface application 14c can be built using JavaServer Faces and JavaServer Pages and/or Macromedia Flex. The processors 14a fetch the interface application 14c from the storage devices 14b and execute the interface application 14c in order to generate and display one or more screens, as described below with respect to FIGS. 3-8.

As also shown in FIG. 2, the interface 14 includes an input/output module 14d connected to the processors 14a. The input/output module 14d can be connected to one or more output devices 14e, such as a video monitor, and can transmit information to the output devices 14e. For example, the input/output module 14d can transmit screens generated by the interface application 14c to the output devices 14e. In some embodiments, the one or more output devices 14e also include a printer for printing screens generated by the interface application 14c. In addition, the input/output module 14d can be connected to one or more input devices 14f, such as a mouse, a joystick, a microphone, a keyboard, a touch screen, etc. A user interacting with the interface 14 can use the input devices 14f to provide information and/or instructions to the input/output module 14d, and the input/output module 14d can forward the information and/or instructions to the processors 14a executing the interface application 14c.

In some embodiments, the input/output module 14d is also connected to the transaction devices 12 via the network 16 and obtains the information packs from the transaction devices 12. The input/output module 14d can forward the information packs to the processors 14a. In some embodiments, the input/output module 14d and/or the processors 14a can store information collected from the input devices 14f and/or the transaction devices 12 and/or information generated by the processors 14a executing the interface application 14c in the storage devices 14b. The processors 14a can use the stored information when executing the interface application 14c. In addition, in some embodiments, the input/output module 14d can transmit information (e.g., commands, queries, alerts, etc.) to the transaction devices 12 and/or other devices external to the system 10 as directed by the processor 14a executing the interface application 14c. For example, the interface 14 can be connected to an electronic financial transaction system that it can use to transfer funds between accounts based on the operation of the transaction devices 12 (e.g., when a particular account is low). The interface 14 can automatically generate and transmit information to other devices or systems and/or can generate and transmit information to other devices or systems based on commands or instructions manually provided by a user interacting with the interface 14.

In some embodiments, components of the interface 14 can be distributed between a server and a client computing device. For example, the processors 14a, the storage devices 14b, the interface application 14c, and input/output module 14d can be included in a server, and the server can transmit screens (and/or other information) generated by the interface application 14c to the client computing device executing a browser-application, such as Microsoft's Internet Explorer or Mozilla Firefox, connected to the server over a network, such as the Internet. The client computing device can include output devices, such as a video monitor, and input devices, such as a keyboard and a mouse. The client computing device can display the screens transmitted from the server to a user, and the user can interact with the screens via the input devices and provide information (e.g., instructions, commands, queries, preferences, etc.) to the client computing device. The client computing device can forward the information provided by the user back to the server, and the server can generate screens or other responses accordingly.

FIG. 3 illustrates a logon screen 20 displayed by the interface 14 according to one embodiment of the invention. In some embodiments, the interface 14 can generate and display the logon screen 20 upon initial execution of the interface 14. For security and/or logging purposes, a user of the interface 14 may be required to logon before the user is allowed to use the interface 14. In some embodiments, authorized users of the interface 14 can be pre-established with the interface 14 (or with a separate security system or module). Authorized users can be issued initial logon parameters, such as a user identifier, a password, etc., that the user must enter into the logon screen 20 in order to access and use the interface 14.

Authorized users of the interface 14 can also be established with particular user profiles. The user profiles (which can be included in the interface application 14 and/or managed and stored by a separate security system or module) can define which information packs and/or other functionality (e.g., available preferences, selection mechanisms, options, etc.) provided by the interface 14 the user is allowed to access. The interface 14 can generate and display screens to an authorized user based on the details specified in a user profile associated with the authorized user. In some embodiments, the user profiles can provide a user name that the interface 14 can included in the screens generated for a particular user.

As shown in FIG. 3, the logon screen 20 can include a user identifier (“UserId”) field 22 and a password field 24. A user of the interface 14 can enter their user identification and their password using the fields 22 and 24 with one or more input devices 14f. The user can then select a logon selection mechanism 26 (e.g., a button, radio button, checkbox, etc.) with an input device 14 in order to submit their user identification and password to the interface 14 for authentication and/or verification. It should be understood that other types of authentication information can be obtained through the logon screen 20 and one or more input devices 14f. For example, the input devices 14f can include biometric readers or scanners, card readers, bar code readers, etc. for obtaining authentication information from a user. In some embodiments, the logon screen 20 can also include a selection mechanism for changing or resetting authentication information for a particular user.

After the user selects the logon selection mechanism 26, the interface 14 (or a separate security system or module) can authenticate and verify that the authentication information provided by the user identifies a user authorized to use the interface 14. If the interface 14 (or a separate security system or module) determines that information provided by the user does not identify an authorized user of the interface 14, the interface 14 can redisplay the logon screen 20. The interface 14 can also display a message or alert that indicates that the information provided by the user does not identify an authorized user.

The user can also select the cancel selection mechanism 28 in order to end the logon process. Selecting the cancel selection mechanism 28 can clear the user identifier filed 22 and the password field 24 or can terminate the interface 14 (e.g., terminate the execution of the interface application 14 with the processors 14a).

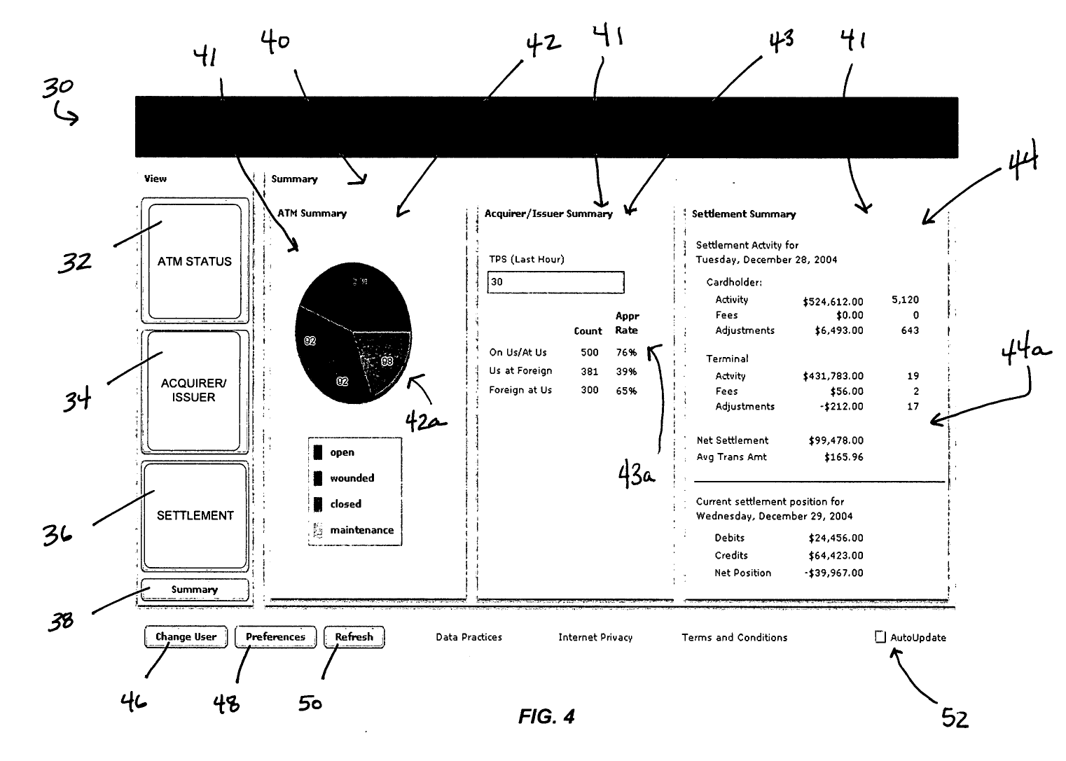

If the interface 14 (or a separate security system or module) determines that the information provided by the user via the logon screen 20 identifies an authorized user, the interface 14 can generate and display a summary view screen. FIG. 4 illustrates a summary view screen 30 according to one embodiment of the invention. As shown in FIG. 4, the summary view screen 30 includes one or more detail selection mechanisms 31. For example, the summary view screen 30 can include an ATM status detail selection mechanism 32, an acquirer/issuer activity detail selection mechanism 34, and a settlement position detail selection mechanism 36. In some embodiments, the summary view screen 30 can include additional detail selection mechanisms 31 for additional information packs available for display by the interface 14. The interface 14 can also generate the summary screen 30 with fewer detail selection mechanisms 31 depending on the availability of an information pack or based on a user profile associated with the user interacting with the interface 14. Alternatively, the interface 14 can disable detail selection mechanisms 31 for information packs that are not accessible to a particular user based on the user's profile. If the user selects a particular detail selection mechanism 31, the interface 14 can generate and display a detail screen associated with the information pack associated with the selected detail selection mechanism 31.

The summary view screen 30 also includes a summary view selection mechanism 38. If a user selects the summary view selection mechanism 38, the interface 14 can generate and display the summary view screen 30.

As shown in FIG. 4, the summary view screen 30 includes a summary section 40 that includes a summary section 41 for each information pack represented by a detail selection mechanism 31 included on the summary view screen 30 (e.g., those information packs accessible to a particular user). For example, the summary sections 41 can include an ATM summary section 42, an acquirer/issuer summary section 43, and a settlement summary section 44. Additional summary sections can be generated and tailored for whatever types of transaction devices 12 are connected to the network 16.

The ATM summary section 42 can include a graphical representation 42a, such as a bar graph or a pie chart, that indicates the percentage and/or number of ATMs and their status. For example, the graphical representation 42a can display the percentage of ATMs with a status of “open,” the percentage of ATMs with a status of “wounded,” the percentage of ATMs with a status of “closed,” and a percentage of ATMs with a status of “closed for maintenance.” In some embodiments, selecting (e.g., moving a cursor over) a portion of the graphical representation 42a can modify the graphical representation 42a and display more information for the portion of the graphical representation 42a. For example, selecting a section of a pie chart included in the graphical representation 42a can display information such as the percentage amount and/or number or count corresponding to that section.

The acquirer/issuer summary section 43 can include one or more transaction statistics 43a, such as the average number of transactions per second, the number of transactions processed, and approval rates for transactions processed. The transaction statistics 43a can be calculated over a predetermined time period, such as over the last hour of processing, over the current day, over the current week, over the current month, over the current year, or since the last refresh. The transaction statistics 43a can be separated based on transaction origination and/or processing. For example, transaction statistics 43a can be separated into three categories including transactions initiated and processed by transaction devices 12 included in the system 10, transactions initiated at transaction devices external to the system 10 but processed by transaction devices 12 included in the system 10, and transactions initiated at transaction devices 12 included in the system 10 and processed by transaction devices external to the system 10. In some embodiments, the acquirer/issuer summary section 43 can include a list of available financial institutions and/or switches associated with the transaction devices 12 included in the system 10, and the transaction statistics 43a can be separated accordingly to the available financial institutions and/or switches.

The settlement summary section 44 can include financial activity information 44a for the system 10. The financial activity information 44a can include financial activity information for a previous day, such as the total amount and number of transactions conducted (e.g., initiated and/or processed) with the system 10, the total amount and number of fees collected with the system 10, and the total amount and number of adjustments made with the system 10 for cardholders and for transaction devices 12 included in the system 10 for a previous day. The financial activity information 44a can also include a net settlement amount and an average transaction amount for the previous day. In addition, the financial activity information 44a can include financial activity information for a current day, such as a total debit amount, a total credit amount, and a net position amount.

As shown in FIG. 4, the summary view screen 30 includes a change user selection mechanism 46, a preferences selection mechanism 48, a refresh selection mechanism 50, and an automatic update (“AutoUpdate”) selection mechanism 52. If a user selects the change user selection mechanism 46, the interface 14 can logout the current user interacting with the interface 14 and can generate and display the logon screen 20. A new user can then provide authentication information in order to login and use the interface 14.

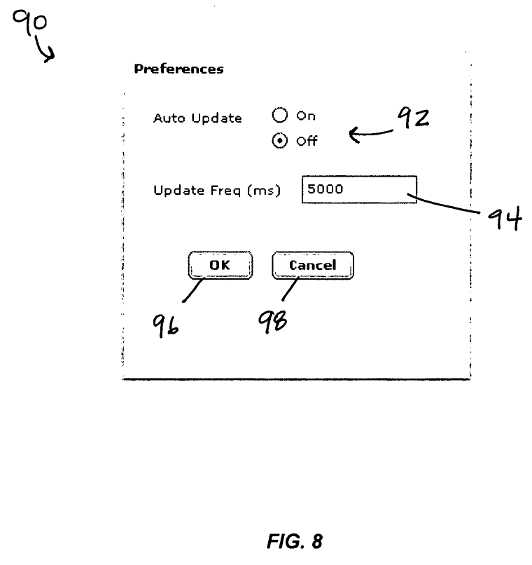

If a user selects the preferences selection mechanism 48, the interface 14 can generate and display a user preferences screen. As described below with respect to FIG. 8, a user can use a user preferences screen to set preferences for using the interface 14. For example, a user can set refresh rate preferences using a user preferences screen.

If a user selects the refresh selection mechanism 50 the interface 14 can modify the currently displayed screen by causing the interface 14 to refresh or re-generate the currently displayed screen, such as the summary view screen 30, based on the most current information packs received from the transaction devices 12. In some embodiments, the interface 14 can also query one or more transaction devices 12 for updated information in order to refresh a currently displayed screen. The interface 14 can also re-generate the currently displayed screen based on the most current user preferences and/or the most recent user profile.

If a user selects or turns on the automatic update selection mechanism 52, the interface 14 can automatically modify a currently displayed screen by refreshing or re-generating a currently displayed screen based on a predetermined frequency or based on the occurrence of one or more predetermined events. In some embodiments, a user can set the predetermined frequency and/or the predetermined events by selecting the preferences selection mechanism 48 and accessing a user preferences screen. When a user selects or turns on the automatic update selection mechanism 52, the refresh selection mechanism 50 can be disabled or removed from a currently displayed screen, and, when a user re-selects or turns off the automatic update selection mechanism 52, the refresh selection mechanism 50 can be enabled or re-added to a currently displayed screen. In some embodiments, the screens generated and displayed with the interface 14 can display a time and/or date of the last refresh (e.g., manual or automatic) performed by the interface 14. The screens can also display a current time.

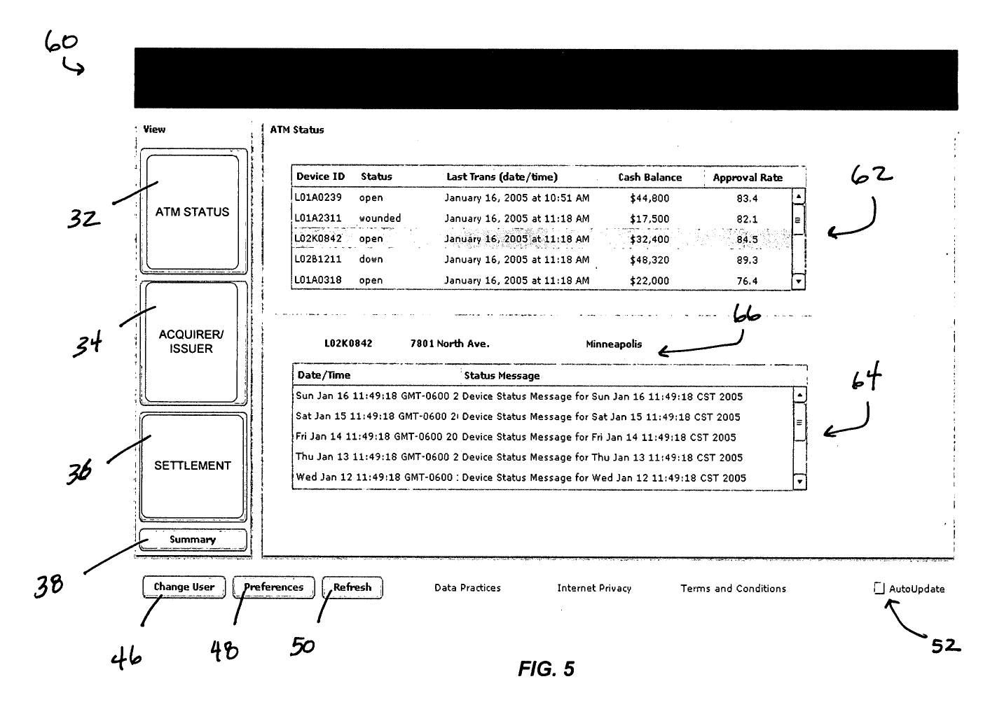

If the user selects the ATM status detail selection mechanism 32 on the summary view screen 30 or on another screen generated by the interface 14 that includes the ATM status detail selection mechanism 32, the interface 14 can generate and display an ATM status screen. FIG. 5 illustrates an ATM status screen 60 according to one embodiment of the invention. As shown in FIG. 5, the ATM status screen 60 includes the ATM status detail selection mechanism 32, the acquirer/issuer activity detail selection mechanism 34, the summary detail selection mechanism 36, the summary view selection mechanism 38, the change user selection mechanism 46, the preferences selection mechanism 48, the refresh selection mechanism 50, and the automatic update selection mechanism 52 as described above with respect to FIG. 4. The ATM status screen 60, as shown in FIG. 5, also includes a transaction device graphical representation (e.g., a list) 62, a message list 64, and a location identifier 66. The transaction device list 62 can list one or more transaction devices 12 included in the system 10. In some embodiments, the transaction device list 62 can list only those transaction devices 12 included in the system 10 that the user is authorized to view (e.g., based on a user profile).

For each transaction device 12 listed in the transaction device list 62, the transaction device list 62 can display device parameters, such as an identifier of the device, a current status of the device (e.g., open, closed, closed for maintenance, or wounded), a data and/or time of a recent transaction processed by the device, a current cash balance in the device, and an approval rate for the device. The approval rate for a transaction device 12 can be calculated based on a predetermined time period, such as based on transactions processed by the transaction device 12 for the current day from midnight through the time of the last refresh.

In some embodiments, the user can modify the transaction device list 62. For example, the user can sort the devices listed in the transaction device list 62 by a particular device parameter. To sort the transaction device list 62 by a particular device parameter, the user can select a column heading included in the transaction device list 62 associated with the device parameters. In some embodiments, selecting a column heading once can initially sort the transaction device list 62 in either ascending or descending order based on the selected column heading and selecting a column heading sequentially (e.g., selecting the column heading twice in succession) can sort the transaction device list 62 in the reverse order. The column heading corresponding to the device parameter currently used to sort the transaction device list 62 can be displayed with an arrow or other graphical or textual indication. Alternatively or in addition, the transaction device list 62 can include selection mechanisms (e.g., radio buttons) that the user can select or turn on and off in order modify (e.g., sort) the transaction device list 62 (e.g., show the transaction devices 12 with the highest approval rates or transaction devices 12 with the lowest approval rates in the transaction device list 62).

The user can also modify the message list 64 by selecting (e.g., clicking or double-clicking) a particular transaction device 12 listed in the transaction device list 62. For example, when the user selects a particular transaction device 12, the message list 64 can display recent messages generated by the selected transaction device 12. In some embodiments, the message list 64 can display up to 10 messages generated by the selected transaction device (e.g., the 10 most recent messages, the 10 most important messages, etc.). For each message displayed in the message list 64, the message list 64 can display message parameters, such as the time and/or date the message was generated and information included in the message. As described above with respect to the transaction device list 62, the user can modify the message list 64. For example, the user can sort the message list 64 based on a particular message parameter by selecting a column heading of the message list 64 associated with a particular message parameter. In some embodiments, selecting a column heading once can initially sort the message list 64 in either ascending or descending order based on the selected column heading and selecting a column heading sequentially (e.g., selecting the column heading twice in succession) can sort the transaction device list in the reverse order. The column heading corresponding to the message parameter currently used to sort the message list 64 can be displayed with an arrow or other graphical or textual indication. The location identifier 66 can also display a location (e.g., an address, a city, a state, etc.) of a transaction device 12 selected in the transaction device list 62.

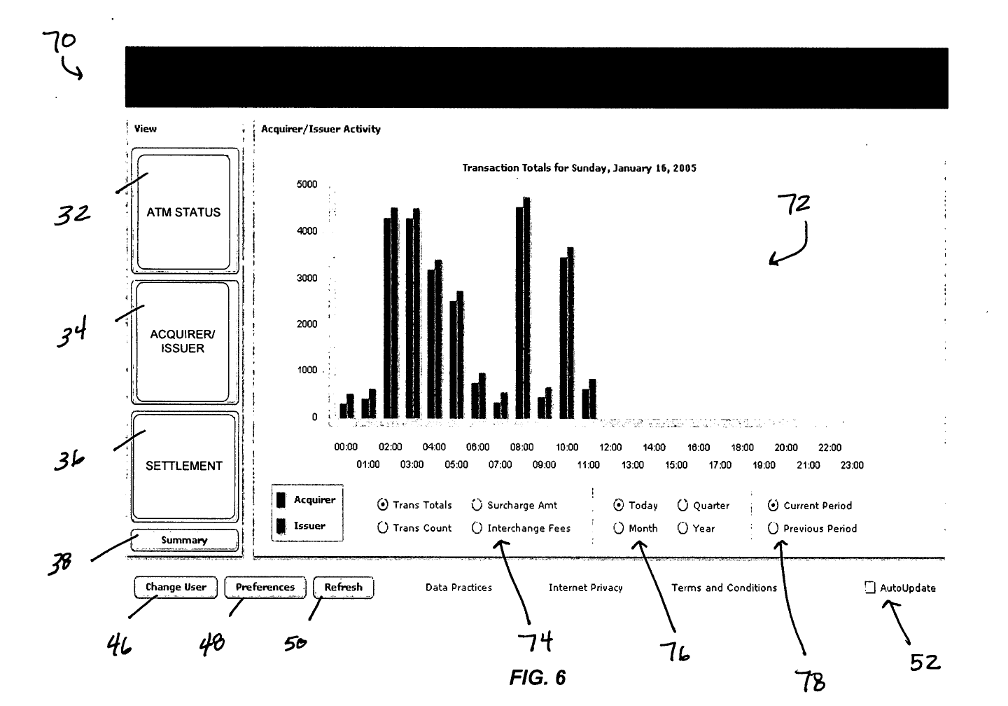

If the user selects the acquirer/issuer activity detail selection mechanism 34 on the summary view screen 30 or on another screen generated by the interface 14 that includes the acquirer/issuer activity detail selection mechanism 34, the interface 14 can generate and display an acquirer/issuer activity screen. FIG. 6 illustrates an acquirer/issuer activity screen 70 according to one embodiment of the invention. As shown in FIG. 6, the acquirer/issuer activity screen 70 includes the ATM status detail selection mechanism 32, the acquirer/issuer activity detail selection mechanism 34, the summary detail selection mechanism 36, the summary view selection mechanism 38, the change user selection mechanism 46, the preferences selection mechanism 48, the refresh selection mechanism 50, and the automatic update selection mechanism 52 as described above with respect to FIG. 4. In addition, the acquirer/issuer activity screen 70 can include a graphical representation 72, such as a bar graph or a speedometer graph. The graphical representation 72 can display one or more types of acquirer/issuer activity information. For example, the graphical representation 72 can display transaction totals (i.e., amounts), transaction counts, surcharge amounts, and/or surcharge fee amounts. As shown in FIG. 6, the graphical presentation 72 can display separate activity information for acquirers and issuers.

In some embodiments, the graphical representation 72 can display acquirer/issuer activity information for a predetermined time period, such as for the current day, for the current month, for the current quarter, or for the current year. The acquirer/issuer activity information for a predetermined time period can also be subdivided to display acquirer/issuer activity information at intervals within the predetermined time period. For example, the acquirer/issuer activity information can be subdivided by the hour within the current day, subdivided by the day within the current month, subdivided by the week within the current quarter, or subdivided by the month within the current year. In some embodiments, the acquirer/issuer activity information also includes acquirer/issuer activity information for a previous time period, such as the previous day, the previous month, the previous quarter, or the previous year.

As shown in FIG. 6, the acquirer/issuer activity screen 70 can include an activity information type section 74, a time period section 76, and a current/previous time period section 78. The user interacting with the interface 14 can use selection mechanisms included in the activity information type section 74, the time period section 76, and the current/previous time period section 78 to modify the graphical representation 72. For example, the user can select the type of activity information and the time period of the activity information to be displayed in the graphical representation 72. In some embodiments, the activity information type section 74 can include one or more selection mechanisms (e.g., radio buttons) that allow the user to select a type of acquirer/issuer activity information and modify the information displayed in the graphical representation 72. As shown in FIG. 6, the user can select transaction totals (i.e., amounts), transaction counts, surcharge amounts, or surcharge fee amounts to be displayed in the graphical representation 72.

Similarly, the time period section 76 can include one or more selection mechanisms (e.g., radio buttons) that allow the user to modify and select the time period over which the selected type of acquirer/issuer information (e.g., selected via the activity information type section 74) should be displayed in the graphical representation 72. For example, the user can select that the acquirer/issuer activity information be displayed over a time period of one today (“Today”), one month, one quarter, or one year.

In addition, the user can use selection mechanisms (e.g., radio buttons) included in the current/previous time period section 78 to modify and select either a current time period or a previous time period. For example, if the user selects a time period of one month using the selection mechanisms included in the time period section 76 and selects a current time period using the selection mechanisms included in the current/previous time period section 78, the graphical representation 72 can be modified to display acquirer/issuer activity information for the current month. Alternatively, if the user selects a time period of one month using the selection mechanisms included in the time period section 76 and selects a previous time period using the selection mechanisms included in the current/previous time period section 78, the graphical representation 72 can be modified to display acquirer/issuer activity information for the previous month. In some embodiments, the current/previous time period section 78 can include a selection mechanism for modifying the graphical representation 72 to display acquirer/issuer activity information corresponding to both the current time period and the previous time period.

Depending on the type of acquirer/issuer activity information, time period, and current or previous time period selected by the user via the activity information type section 74, the time period section 76, and a current/previous time period section 78, the graphical representation 72 can also be modified to include a title or other textual label that indicates what information is displayed in the graphical representation 72.

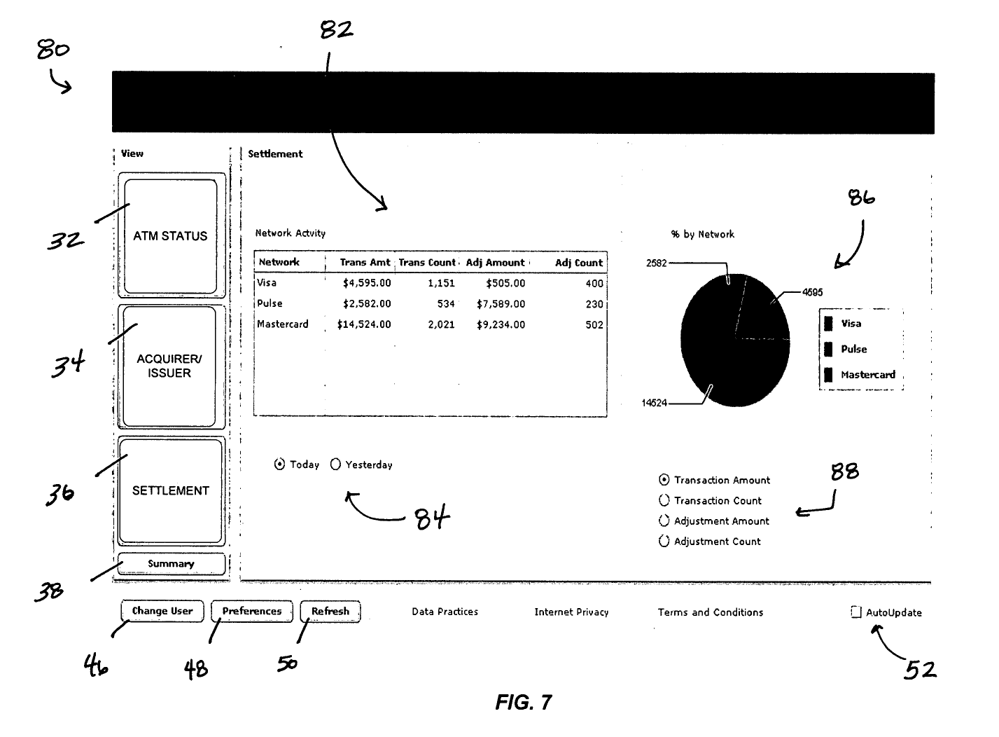

If the user selects the settlement position detail selection mechanism 36 on the summary view screen 30 or on another screen generated by the interface 14 that includes the settlement position detail selection mechanism 36, the interface 14 can generate and display a settlement position screen. FIG. 7 illustrates a settlement position screen 80 according to one embodiment of the invention. As shown in FIG. 7, the settlement position screen 80 includes the ATM status detail selection mechanism 32, the acquirer/issuer activity detail selection mechanism 34, the summary detail selection mechanism 36, the summary view selection mechanism 38, the change user selection mechanism 46, the preferences selection mechanism 48, the refresh selection mechanism 50, and the automatic update selection mechanism 52 as described above with respect to FIG. 4. In addition, as shown in FIG. 7, the settlement position screen 80 can include a network activity list 82, a current/previous activity section 84, a graphical representation 86, and an activity type section 88.

The network activity list 82 can list each transaction device 12 or network of transaction devices 18 (e.g., VISA, Pulse, MasterCard) included in the system 10. For each transaction device 12 or network of transaction devices 18, the network activity list 82 can display one or more device/network parameters, such as a transaction device or network identifier, a total amount of transactions, a total count of transactions, a total amount of adjustments, and a total count of adjustments. In some embodiments, the user can modify the network activity list 82 by sorting the network activity list 82 based on a particular device/network parameter. To sort the network activity list 82 based on a particular device/network parameter, the user can select (e.g., click on) a column heading included in the network activity list 82. In some embodiments, selecting a column heading once can initially sort the network activity list 82 in either ascending or descending order based on the selected column heading and selecting a column heading sequentially (e.g., selecting the column heading twice in succession) can sort the transaction device list in the reverse order. The column heading corresponding to the device/network parameter currently used to sort the network activity list 82 can be displayed with an arrow or other graphical or textual indication.

In some embodiments, the user can also modify the information displayed in the network activity list 82 using the current/previous activity section 84. The current/previous activity section 84 can include one or more selection mechanisms (e.g., radio buttons) that allow the user to select whether the information displayed in the network activity list 82 corresponds to current information (e.g., information for the current day) or previous information (e.g., information for the previous day).

As shown in FIG. 7, the graphical representation 86 can include a pie chart or another type of graph or chart that displays the information currently displayed in the network activity list 82 (e.g., based on the selections indicated in the current/previous activity section 84) for each listed transaction device 12 and/or network of transaction devices 18. In some embodiments, the user can use selection mechanisms (e.g., radio buttons) included in the activity type section 88 to modify the graphical representation 86 to display one of the device/network parameters included in the network activity list 82. For example, the user can select the transaction amount, the transaction count, the adjustment amount, or the adjustment count for each transaction device 12 and/or network of transaction devices 18 listed in the network activity list 82. In some embodiments, selecting (e.g., moving a cursor over) a portion of the graphical representation 86 can modify the graphical representation 86 to display more information for the selected portion of the graphical representation 86. For example, selecting a section of a pie chart included in the graphical representation 82 can display information such as the percentage amount and/or number or count corresponding to that section.

In some embodiments, depending on the time period (e.g., current or previous) and the device/network parameter selected to be displayed in the graphical representation 86 by the user via the current/previous activity section 84 and the activity type section 88, the graphical representation 86 can be modified include a title or other textual label that indicates what information is displayed in the graphical representation 86.

As described above with respect to FIG. 4, if the user selects the preferences selection mechanism 48 on the summary screen 30 or on another screen generated by the interface 14 that includes the preferences selection mechanism 48, the interface 14 can generate and display a user preferences screen. FIG. 8 illustrates a user preferences screen 90 according to one embodiment of the invention. The user can use the user preferences screen 90 to modify the functionality of the interface 14.

As shown in FIG. 8, the user preferences screen 90 can include an automatic update preferences section 92, an update frequency preferences section 94, an “okay” or submit selection mechanism 96, and a cancel selection mechanism 98. The automatic update preferences section 92 can include one or more selection mechanisms and/or fields for turning on or off the automatic refresh or update functionality of the interface 14. In some embodiments, if a user turns off the automatic refresh functionality of the interface 14, the interface 14 only re-generates screens (in order to obtain the most current information packs or other information) when the user selects the refresh selection mechanism 50 as described above with respect to FIG. 4.

The update frequency preferences section 94 can include one or more selection mechanisms and/or fields for setting a frequency for the interface 14 to automatically re-generate screens. The frequency can be specified in predetermined units, such as a number of minutes between refreshes or a number of refreshes per minute, per second, per millisecond, etc. In some embodiments, the selection mechanisms and/or fields included in the update frequency preferences section 94 can include a drop-down menu that can provide a list of available refresh frequencies. Alternatively, the interface 14 can verify a manually entered refresh frequency in order to ensure that an entered refresh frequency is numeric, within a predetermined range, etc. The update frequency preferences section 94 can be disabled or removed from the user preferences screen 90 if automatic refresh is currently disabled or turned off.

In some embodiments, the user can also use the user preferences screen 90 to modify other functionality of the interface 14, such as size, color, shape, layout, orientation, parameters, language, currency, etc., of the one or more screens generated and displayed by the interface 14. For example, a user may be allowed to select a type of graph or chart included in a graphical representation, the default parameters used to sort a list, the number of rows to be included in a list, the parameters to be displayed in a list, the time period over which to calculate information, etc. In addition, the user may use the user preferences screen 90 to voluntarily disable particular information packs displayed by the interface 14 in order to obtain screens tailored to the information to be monitored or analyzed by the user. Each screen generated and displayed by the interface 14 may also include selection mechanisms or fields that allow a user interacting with the interface 14 to provider user preferences associated with the information displayed on the screen (e.g., radio buttons for selecting a particular type of chart of graph included in a graphical representation).

User preferences provided by a user of the interface 14 via the user preferences screen 90 can be applied only to a current session (e.g., are reset after the user logouts) or can be stored in a user profile associated with the user and applied to future sessions (e.g., are applied each time the user logins to the interface 14).

After the user has selected or entered user preferences via the user preferences screen 90, the user can select the “okay” or submit selection mechanism 96 in order apply the preferences and/or store the preferences for later use. The interface 14 can also display a previously-displayed screen to the user. Alternatively, if the user selects the cancel selection mechanism 98, the interface 14 can close the user preferences screen 90 without applying or storing any preferences selected or entered by the user via the user preferences screen 90 and can display a previously displayed screen to the user.

Various features and advantages of the invention are set forth in the following claims.

1. A graphical user interface for use with a plurality of transaction devices, the graphical user interface comprising:
a plurality of detail screens including detail information associated with a plurality of measurable features of the plurality of transaction devices; and
a summary screen including a summary section for each of the plurality of measurable features of the plurality of transaction devices and a detail selection mechanism for each of the plurality of measurable features of the plurality of transaction devices.

2. The graphical user interface of claim 1 wherein the plurality of measurable features of the plurality of transaction devices includes at least one of an automated teller machine status feature, an acquirer/issuer activity feature, and a settlement position feature.

3. The graphical user interface of claim 1 wherein at least one of the summary screen and the plurality of detail screens includes a refresh selection mechanism and wherein the graphical user interface refreshes at least one of the summary screen and the plurality of detail screens based on a user selecting the refresh selection mechanism.

4. The graphical user interface of claim 1 wherein at least one of the summary screen and the plurality of detail screens includes an automatic update selection mechanism and wherein the graphical user interface automatically refreshes at least one of the summary screen and the plurality of detail screens at a predetermined frequency based on a user selecting the automatic update selection mechanism.

5. The graphical user interface of claim 1 further comprising at least one selection mechanism for modifying at least one of the summary screen and the plurality of detail screens.

6. The graphical user interface of claim 5 wherein the at least one selection mechanism includes at least one of a button, a selectable heading, a radio button, a cursor, and a field.

7. The graphical user interface of claim 5 wherein the at least one selection mechanism modifies at least one of the summary screen and the plurality of detail screens by changing a type of a graphical representation displayed by at least one of the summary screen and the plurality of detail screens.

8. The graphical user interface of claim 5 wherein the at least one selection mechanism modifies at least one of the summary screen and the plurality of detail screens by changing information displayed in a graphical representation displayed by at least one of the summary screen and the plurality of detail screens.

9. The graphical user interface of claim 5 wherein the at least one selection mechanism modifies at least one of the summary screen and the plurality of detail screens by changing an order of the information displayed in a graphical representation displayed by at least one of the summary screen and the plurality of detail screens.

10. The graphical user interface of claim 5 wherein the at least one selection mechanism modifies at least one of the summary screen and the plurality of detail screens by refreshing at least one of the summary screen and the plurality of detail screens.

11. The graphical user interface of claim 1 wherein the summary screen includes a graphical representation of a status of a plurality of transaction devices.

12. The graphical user interface of claim 1 wherein at least one of the plurality of detail screens displays a transaction device list, the transaction device list displaying a plurality of transaction devices and a plurality of device parameters for each of the plurality of transaction devices.

13. The graphical user interface of claim 12 wherein the plurality of device parameters includes at least one of a device identifier, a device status, a transaction time, a cash balance, and an approval rate.

14. The graphical user interface of claim 12 wherein at least one of the plurality of detail screens displays a message list displaying a plurality of messages associated with a transaction device displayed in the transaction device list.

15. The graphical user interface of claim 1 wherein the summary screen displays an approval rate for the plurality of transaction devices.

16. The graphical user interface of claim 15 wherein at least one of the plurality of detail screens displays an approval rate for each of the plurality of transaction devices.

17. The graphical user interface of claim 1 wherein the summary screen displays transaction statistics.

18. The graphical user interface of claim 17 wherein the transaction statistics include at least one of an average number of transactions, a number of transactions processed, and an approval rate for transactions processed.

19. The graphical user interface of claim 17 wherein the transaction statistics include statistics for transactions initiated and processed with at least one of the plurality of transaction devices, statistics for transactions initiated with at least one of the plurality of transaction devices and processed by an external transaction device, and transactions initiated with an external transaction device and processed with at least one of the plurality of transaction devices.

20. The graphical user interface of claim 1 wherein the summary screen displays financial information including at least one of an amount of transactions processed, a number of transactions processed, an amount of fees collected, a number of fees collected, an amount of adjustments made, and a number of adjustments made.

21. The graphical user interface of claim 20 wherein the financial information includes financial information for at least one of a current day and a previous day.

22. The graphical user interface of claim 20 wherein the financial information includes at least one of a net settlement amount and an average transaction amount.

23. The graphical user interface of claim 20 wherein the financial information includes at least one of a debit amount, a credit amount, and a net position amount.

24. A method of monitoring a plurality of transaction devices, the method comprising:
receiving information from the plurality of transaction devices, the information related to a plurality of measurable features of the plurality of transaction devices; and
generating a summary screen based on the information, the summary screen including a summary section for each of the plurality of measurable features and a detail selection mechanism for each of the plurality of measurable features.

25. The method of claim 24 further comprising generating a plurality of detail screens based on a user selecting the detail selection mechanism for each of the plurality of measurable features.

26. The method of claim 24 wherein the received information is related to at least one of an automated teller machine status feature, an acquirer/issuer activity feature, and a settlement position feature.

27. The method of claim 24 further comprising refreshing at least one of the summary screen and a plurality of detail screens based on a user selecting a refresh selection mechanism.

28. The method of claim 24 further comprising automatically refreshing at least one of the summary screen and a plurality of detail screens at a predetermined frequency based on a user selecting an automatic update selection mechanism.

29. The method of claim 24 further modifying at least one of the summary screen and a plurality of detail screens based on a user selecting a selection mechanism.
